(19) United States
(12) Patent Application Publication
(10) Pub. No.: US 2025/0077408 A1
(43) Pub. Date: Mar. 6, 2025

(54) STORAGE CONTROLLER, STORAGE DEVICE, AND HOST-STORAGE SYSTEM INCLUDING THE STORAGE CONTROLLER

(71) Applicant: SAMSUNG ELECTRONICS CO., LTD., SUWON-SI (KR)

(72) Inventors: Byung Kyu CHO, Suwon-si (KR); Yong Seok WON, Suwon-si (KR)

(21) Appl. No.: 18/774,153

(22) Filed: Jul. 16, 2024

(30) Foreign Application Priority Data
Aug. 30, 2023 (KR) 10-2023-0114799

(51) Int. Cl. G06F 12/02

(52) U.S. Cl. CPC G06F 12/0223

(57) ABSTRACT

A storage controller, storage device, and host-storage system are provided. The storage controller includes a physical function allocated to a physical machine of a host that processes first data; a first virtual function allocated to a first virtual machine of the host that processes second data; a second virtual function allocated to a second virtual machine of the host that processes third data; a rescheduling unit configured to assign priority tokens to each of the physical function, the first virtual function, and the second virtual function; and a multi-tenant power control unit configured to receive sub-power states of the physical function, the first virtual function, and the second virtual function, and allocate a power budget to each of the physical function, the first virtual function, and the second virtual function based on the assigned priority tokens and the sub-power states.

### CROSS-REFERENCE TO RELATED APPLICATION

This application claims priority under 35 U.S.C. 119 to Korean Patent Application No. 10-2023-0114799, filed on Aug. 30, 2023 in the Korean Intellectual Property Office, and all the benefits accruing therefrom, the contents of which in its entirety are herein incorporated by reference.

### BACKGROUND

### 1. Technical Field

The present disclosure relates to a storage controller, a storage device, and a host-storage system including the storage controller.

### 2. Description of the Related Art

There are nonvolatile memory-based data storage devices, such as solid state drives (SSDs), and various interfaces such as Serial AT Attachment (SATA), Peripheral Component Interconnect Express (PCIe), and Serial Attached SCSI (SAS) that are utilized for such data storage devices. The performance of SSDs is steadily improving, accompanied by an increasing amount of concurrent data processing. However, traditional interfaces such as SATA are not tailored for data storage devices, such as SSDs, thus fundamentally limiting their capabilities. Consequently, as part of the efforts to establish a standardized interface suitable for SSDs, Non-Volatile Memory Express (NVMe) was born. NVMe, which is a register-level interface for communication between a data storage device, such as an SSD, and host software, is based on conventional PCIe buses, but optimized for SSDs.

Meanwhile, with the advancement of semiconductor manufacturing technology, the operational speed of host devices, such as computers, smartphones, and smart pads, that communicate with storage devices is on the rise. As the operational speed of host devices improves, virtualization, which enables the execution of various virtual functions within a single host device, is being introduced. Furthermore, storage devices are evolving in line with its commercialization objectives, and research is ongoing for base-isolation storage systems that control power in minimum units of physical functions and for full-isolation storage systems that control power in minimum units of virtual functions.

### SUMMARY

Aspects of the present disclosure provide a storage controller that efficiently allocates power budget to physical and virtual functions.

Aspects of the present disclosure also provide a storage device, where power budget is efficiently allocated to physical and virtual functions.

Aspects of the present disclosure also provide a host-storage system, where the power budget of a storage device is efficiently allocated to physical and virtual functions.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a storage controller comprising a physical function allocated to a physical machine of a host that processes first data; a first virtual function allocated to a first virtual machine of the host that processes second data; a second virtual function allocated to a second virtual machine of the host that processes third data; a rescheduling unit configured to assign priority tokens to each of the physical function, the first virtual function, and the second virtual function; and a multi-tenant power control unit configured to receive sub-power states of the physical function, the first virtual function, and the second virtual function, and allocate a power budget to each of the physical function, the first virtual function, and the second virtual function based on the assigned priority tokens and the sub-power states.

According to an aspect of the present disclosure, there is provided a storage device comprising a storage controller configured to generate a physical function, which is allocated to a physical machine of a host regarding an operation of a vehicle, a first virtual function, which is allocated to a first virtual machine of the host regarding an operation of the vehicle, and a second virtual function, which is allocated to a second virtual machine of the host regarding an operation of the vehicle; a memory device including a first memory region which corresponds to the physical function, a second memory region which corresponds to the first virtual function, and a third memory region which corresponds to the second virtual function; and a power management circuit controlled by the storage controller to manage power supplied to each of the first, second, and third memory regions, wherein the storage controller includes a rescheduling unit, which is configured to assign priority tokens to each of the physical function, the first virtual function, and the second virtual function, and a multi-tenant power control unit, which is configured to receive sub-power states of the physical function, the first virtual function, and the second virtual function, and allocate a power budget to each of the physical function, the first virtual function, and the second virtual function based on the assigned priority tokens and the sub-power states of the physical function, the first virtual function, and the second virtual function, and the power management circuit is controlled by the multi-tenant power control unit to independently manage power supplied to each of the first, second, and third memory regions based on the power budget allocated to each of the physical function, the first virtual function, and the second virtual function.

According to an aspect of the present disclosure, there is provided a host-storage system comprising a host including a physical machine, a first virtual machine, and a second virtual machine; a storage controller configured to generate a physical function allocated to the physical machine, a first virtual function allocated to the first virtual machine, and a second virtual function allocated to the second virtual machine; and a memory device including a first memory region which corresponds to the physical function, a second memory region which corresponds to the first virtual function, and a third memory region which corresponds to the second virtual function, wherein the host is configured to provide a command, which includes a power state field for a storage device including the storage controller and the memory device, and a sub-power state field for at least one of the physical function, the first virtual function, or the second virtual function, and the storage controller is configured to receive the command and allocate a power budget to at least one of the physical function, the first virtual function, or the second virtual function based on the sub-power state field of the command.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail various embodiments thereof with reference to the attached drawings, in which:

FIG. 1 is a schematic view of a vehicle including an electronic control device, according to various embodiments of the present disclosure.

FIG. 2 is a block diagram of the storage device of FIG. 1, according to various embodiments of the present disclosure.

FIG. 3 is a block diagram of a host-storage system, according to various embodiments of the present disclosure.

FIG. 4 is a detailed block diagram of the host-storage system of FIG. 3, according to various embodiments of the present disclosure.

FIG. 5 is a detailed block diagram of memory device of the host-storage system of FIG. 3, according to various embodiments of the present disclosure.

FIG. 6 is a flowchart illustrating the operation of the host-storage system of FIG. 3, according to various embodiments of the present disclosure.

FIG. 7 is a schematic view illustrating an exemplary command issued by the host of FIG. 6, according to various embodiments of the present disclosure.

FIG. 8 presents a table for explaining different sub-power states that can be included in the command of FIG. 7, according to various embodiments of the present disclosure.

FIG. 9 is a flowchart illustrating the operation of a storage controller, according to various embodiments of the present disclosure.

FIG. 10 presents a table for explaining data generated by sensors included in the vehicle of FIG. 1, according to various embodiments of the present disclosure.

FIG. 11 presents a table showing priority tokens and sub-power states assigned to the sensors of FIG. 10 for different vehicle operating modes based on Automotive Safety Integrity Level (ASIL) ratings, according to various embodiments of the present disclosure.

FIGS. 12 through 16 present tables for explaining various cases where the sensors of FIG. 10 share power budget for different vehicle operating modes of the vehicle, according to various embodiments of the present disclosure.

FIG. 17 presents graphs for explaining the reallocation of power budget among the sensors of FIG. 10, according to various embodiments of the present disclosure.

### DETAILED DESCRIPTION

A storage controller, a storage device, and a host-storage system according to various embodiments of the present disclosure will be described with reference to the attached drawings.

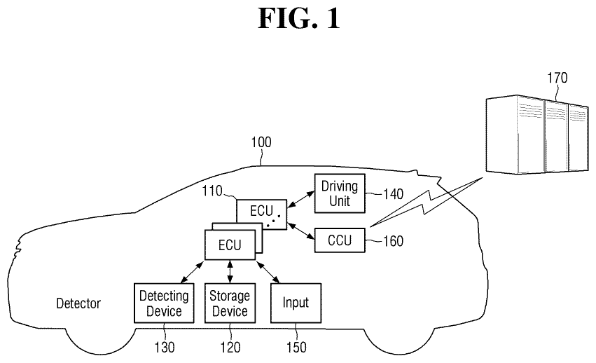

FIG. 1 is a schematic view of a vehicle including an electronic control device, according to various embodiments of the present disclosure.

Referring to FIG. 1, a vehicle 100 may include multiple electronic control units (ECUs) 110 and a storage device 120.

In various embodiments, each of the ECUs 110 may be operatively connected (e.g., electrically, mechanically, and/or communicatively connected) to at least one of multiple device provided in the vehicle 100, and may control the operation of the corresponding device based on one or more function execution commands.

In various embodiments, the multiple devices may include a detecting device 130 for detecting and acquiring information for performing at least one function, and a driving unit 140 for performing the at least one function. The detecting device 130 and the driving unit 140 may each be electrically connected to at least one of the ECUs 110.

In various embodiments, the detecting device 130 may include various detection units and/or an image acquisition unit, and the driving unit 140 may include devices, such as a fan and compressor for an air conditioning device, a fan for a ventilation device, an engine and motor for a power device, a motor for a steering device, a motor and valves for a braking device, and actuators for opening and closing doors or tailgates.

In various embodiments, the ECUs 110 may communicate with the detecting device 130 and the driving unit 140 using, for example, ethernet, low-voltage differential signaling (LVDS) communication, or local interconnect network (LIN) communication.

In various embodiments, the ECUs 110 may determine the initiation of performing a function based on information acquired through the detecting device 130. In response to a determination that a function should be performed, the ECUs 110 may control the operation of the driving unit 140 that performs the corresponding function, and may also control the amount of operation of the driving unit 140 based on the acquired information. The ECUs 110 may store the acquired information in the storage device 120 or may retrieve information stored in the storage device 120 for use.

In various embodiments, the ECUs 110 may control the operation of the driving unit 140 performing a specific function based on a corresponding function execution command input through an input unit 150. The ECUs 110 may also verify settings corresponding to information input through the input unit 150 and control the operation of the driving units 140 performing the specific function based on the verified settings.

In various embodiments, each of the ECUs 110 may control one or more functions independently, or the ECUs 110 may interoperate with one another to control one or more functions together. For example, the ECU 110 for a collision prevention device may output a warning sound through a speaker when the distance from an object, detected by a distance detection unit, is within a specified range.

For example, the ECU 110 for an autonomous driving control device may perform autonomous driving by receiving navigation information, road image information, and obstacle distance information through coordination with the ECUs 110 for an in-vehicle terminal, the image acquisition unit, and the collision prevention device and controlling the power device, the braking device, and the steering device based on the received information.

In various embodiments, a connection control device (CCU) 160 is electrically, mechanically, and communicatively connected to, and communicates with, each of the ECUs 110. The connection control device (CCU) 160 may communicate directly with the ECUs 110 of the vehicle 100, may communicate with external servers, and may perform communication with external terminals through interfaces

In various embodiments, the connection control device 160 may communicate with the ECUs 110 and may communicate with a server 170 through antennas and RF communication.

In various embodiments, the connection control device 160 may communicate wirelessly with the server 170. The connection control device 160 may communicate wirelessly with the server 170 using various wireless communication methods, such as Wi-Fi, Wireless Broadband, Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), and New Radio (NR).

In various embodiments, the vehicle 100 may further include at least one module for the operation of the vehicle 100, such as driving, in addition to the components depicted in FIG. 1.

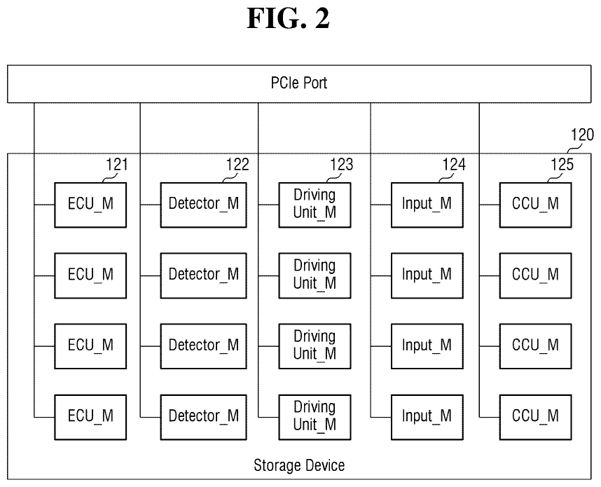

FIG. 2 is a block diagram of the storage device of FIG. 1.

Referring to FIGS. 1 and 2, the storage device 120 may include memories (121, 122, 123, 124, and 125). The memories (121, 122, 123, 124, and 125) may include memories 121, which correspond to the ECUs 110, memories 122, which correspond to the detecting device 130, memories 123, which correspond to the driving unit 140, memories 124, which correspond to the input unit 150, and memories 125, which correspond to the connection control device 160. The memories 121, 122, 123, 124, and 125 may store data generated by their corresponding units or devices and may provide data required for the operations of their corresponding units or devices. The memories (121, 122, 123, 124, and 125) may include nonvolatile memories such as flash memories and/or volatile memories.

In various embodiments, the memories (121, 122, 123, 124, and 125) may be included in the storage device 120. The ECUs 110, the detecting device 130, the driving unit 140, the input unit 150, and the connection control device 160 may share the storage device 120. In some embodiments, a single high-performance storage device 120 may control the ECUs 110, the detecting device 130, the driving unit 140, the input unit 150, and the connection control device 160 of the vehicle 100.

In a case where the vehicle 100 further includes additional modules for processing data associated with the operations of the ECUs 110, the detecting device 130, the driving unit 140, the input unit 150, and the connection control device 160, the storage device 120 may further include one or more additional memories corresponding to the additional modules. In this case, the ECUs 110, the detecting device 130, the driving unit 140, the input unit 150, and the connection control device 160 may share the storage device 120 together with the additional modules.

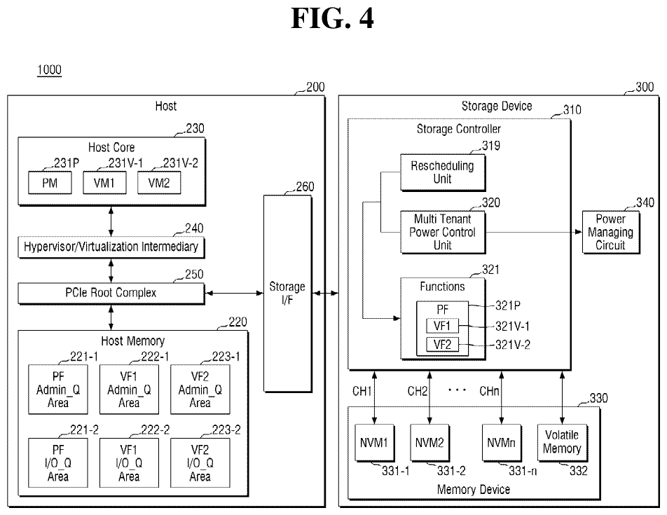

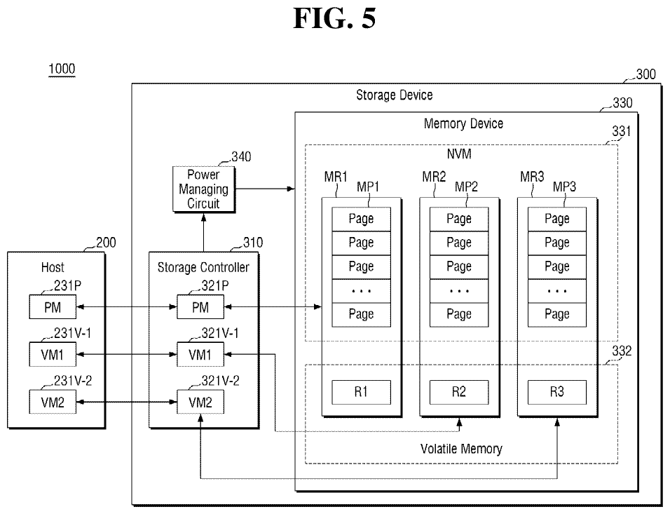

In various embodiments, the storage device 120 may be a Peripheral Component Interconnect Express (PCIe) storage device, particularly, a multi-port and multi-function storage device. The storage device 120 will be described later with reference to FIGS. 4 and 5.

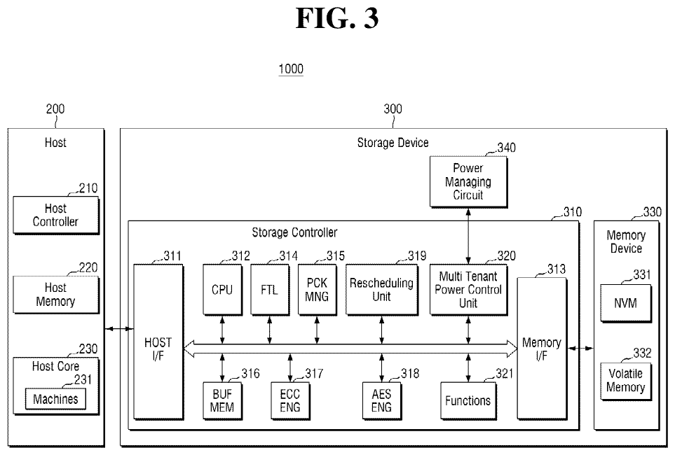

FIG. 3 is a block diagram of a host-storage system according to some embodiments of the present disclosure.

Referring to FIG. 3, a host-storage system 1000 may be equipment for a vehicle, such as a mobile system, a personal computer (PC), a laptop computer, a media player, or a navigation device. The host-storage system 1000 may include a host 200 and a storage device 300. The storage device 300 may include a storage controller 310, a memory device 330, and a power managing circuit 340. The host 200 may include a host controller 210, a host memory 220, and a host core 230.

In various embodiments, the storage device 300 of the host-storage system 1000 may correspond to the storage device 120 of the vehicle 100 of FIG. 1. The storage device 300 may include storage medias for storing data in response to requests from the host 200. For example, the storage device 300 may include at least one of a solid state drive (SSD), an embedded memory, or a removable external memory. If the storage device 300 is an SSD, the storage device 300 may conform to the Non-Volatile Memory Express (NVMe) standard. If the storage device 300 is an embedded memory or external memory, the storage device 300 may conform to the Universal Flash storage (UFS) or Embedded Multi-Media Card (eMMC) standard. The host 200 and the storage device 300 may generate and transmit packets according to adopted standard protocols.

In various embodiments, the memory device 330 may include a nonvolatile memory 331 and a volatile memory 332. When the non-volatile memory 331 of the memory device 330 includes a flash memory, the flash memory may include a two-dimensional (2D) NAND memory array or a three-dimensional (3D) NAND (or vertical NAND (VNAND)) memory array. Alternatively, the storage device 300 may include different types of nonvolatile memories. For example, the storage device 300 may employ magnetic random-access memories (MRAM), spin-transfer torque MRAMs (STT-MRAMs), conductive bridging random-access memories (CBRAMs), ferroelectric random-access memories (FeRAMs), phase-change random-access memories (PRAMs), and/or resistive random-access memories (RRAMs). The volatile memory 332 of the memory device 330 may include a dynamic random-access memory (DRAM) and/or a static random-access memory (SRAM).

In various embodiments, the host controller 210 and the host memory 220 may be implemented as separate semiconductor chips, or the host controller 210 and the host memory 220 may be integrated into the same semiconductor chip. For example, the host controller 210 may be one of multiple modules provided in an application processor, and the application processor may be implemented as a system-on-chip (SoC).

In various embodiments, the host memory 220 may be an embedded memory within the application processor or a nonvolatile memory or memory module located externally to the application processor. The host memory 220 may serve as a buffer memory to temporarily store data to be transmitted to or received from the storage device 300 by the host 200. The host memory 220 may be implemented as a volatile memory, such as an SRAM or DRAM, a nonvolatile memory, such as a PRAM, MRAM, RRAM, FRAM, or a combination of both.

In various embodiments, the host core 230 may control the overall operation of the host 200. For example, the host core 230 may drive a plurality of machines 231 and may further drive a device driver for controlling the host controller 210. The machines 231 may correspond to the modules included in the vehicle 100, such as the ECUs 110, the detecting device 130, the driving unit 140, the input unit 150, and the connection control device 160. The ECUs 110, the detecting device 130, the driving unit 140, the input unit 150, and the connection control device 160 may be included in the host core 230.

In various embodiments, he host controller 210 may manage operations, such as storing data (e.g., recorded data) from a buffer area of the host memory 220 into the nonvolatile memory 331 and storing data (e.g., read data) from the nonvolatile memory 331 into the buffer area of the host memory 220.

In various embodiments, the storage controller 310 may include a host interface 311, a memory interface 313, and a central processing unit (CPU) 312. The storage controller 310 may further include a flash translation layer (FTL) 314, a packet manager 315, a buffer memory 316, an error correction code (ECC) engine 317, and an advanced encryption standard (AES) engine 318. The storage controller 310 may further include a working memory where the FTL 314 is loaded, and operations, such as writing data to, and reading data from, the nonvolatile memory 331 may be controlled by the CPU 312 running the FTL 314. The storage controller 310 may be configured to generate a physical function 321P (“PF”), which may be allocated to a physical machine 231P (“PM”) of a host 200 regarding an operation of a vehicle 100, a first virtual function 321V-1 (“VF1”), which may be allocated to a first virtual machine 231V-1 of the host 200 regarding an operation of the vehicle 100, and a second virtual function 321V-2 (“VF2”), which may be allocated to a second virtual machine 231V-2 of the host 200 regarding an operation of the vehicle 100.

In various embodiments, the host interface 311 may transmit packets to and receive packets from the host 200. Packets transmitted from the host 200 to the host interface 311 may contain commands and data to be written to the nonvolatile memory 331, and packets transmitted from the host interface 311 to the host 200 may include responses to commands or data read from the nonvolatile memory 331. The memory interface 313 may transmit data to be written to the nonvolatile memory 331 or receive data read from the nonvolatile memory 331. The memory interfaces 313 may be implemented to comply with standard protocols such as Toggle or Open NAND Flash Interface (ONFI).

In various embodiments, the FTL 314 may perform various functions, such as address mapping, wear-leveling, and garbage collection. Address mapping is the process of converting logical addresses received from the host 200 into physical addresses for use in storing data in the nonvolatile memory 331. Wear-leveling, which is a technique that ensures uniform usage of blocks in the nonvolatile memory 331 to prevent excessive wear on particular blocks of the nonvolatile memory 331, may be implemented through, for example, firmware technology that balances the erase counts of physical blocks. Garbage collection is a technique used to free up capacity in the nonvolatile memory 331 by copying valid data from existing blocks to new blocks and then erasing the existing blocks.

In various embodiments, the packet manager 315 may generate packets based on the protocol of the negotiated interface with the host 200 or parse various information from packets received from the host 200. Additionally, the buffer memory 316 may temporarily store data to be written to the nonvolatile memory 331 or data read from the nonvolatile memory 331. The buffer memory 316 may be configured within the storage controller 310 or may be placed externally to the storage controller 310.

In various embodiments, the ECC engine 317 may perform error detection and correction functions for data read from the nonvolatile memory 331. Specifically, the ECC engine 317 may generate parity bits for write data to be written to the nonvolatile memory 331, and the generated parity bits may be stored in the nonvolatile memory 331 along with the write data. When data is read from the nonvolatile memory 331, the ECC engine 317 may use parity bits read from the nonvolatile memory 331 along with the read data to detect and correct any errors in the read data and may then output the error-corrected read data.

In various embodiments, the AES engine 318 may perform encryption and/or decryption operations on data input to the storage controller 310, using a symmetric-key algorithm.

In various embodiments, the storage controller 310 may include multiple functions 321, a rescheduling unit 319, and a multi-tenant power control unit 320.

In various embodiments, the functions 321 may be allocated to the machines 231 of the host 200. For example, the machines 231 may access the memory device 330 through the functions 321 allocated thereto.

In various embodiments, the rescheduling unit 319 and the multi-tenant power control unit 320 may be logics in the storage controller 310 for allocating the total power budget of the storage device 300 to the functions 321. The rescheduling unit 319 may assign priority tokens to each of the functions 321.

In various embodiments, the multi-tenant power control unit 320 may allocate the total power budget of the storage device 300 to the functions 321 based on the assigned priority token quantities and the sub-power states of the functions 321. Additionally, the multi-tenant power control unit 320 may manage the power budget assigned to each of the functions 321, and may report the available power budget to the host 200, and the host may reclaim some of the power budget assigned to functions 321 with the available power budget and allocate the reclaimed power budget to functions needing an additional power budget. The multi-tenant power control unit 320 may be configured to receive sub-power states of the physical function 321P (“PF”), the first virtual function 321V-1 (“VF1”), and the second virtual function 321V-2 (“VF2”), and allocate a power budget to each of the physical function 321P (“PF”), the first virtual function 321V-1 (“VF1”), and the second virtual function 321V-2 (“VF2”) based on the assigned priority tokens and the sub-power states.

In various embodiments, the power management circuit 340 may be hardware configured and controlled by the multi-tenant power control unit 320, where the power management circuit 340 may independently manage the power supplied to various memory regions of the memory device 330 based on the power budget assigned to each of the functions 321. The functions and operation of the power management circuit 340 will be described later.

FIG. 4 is a detailed block diagram of the host-storage system of FIG. 3.

Referring to FIG. 4, the host-storage system 1000 may support a queue-based command interface method and may also support a virtualization function. For example, the host-storage system 1000 may support an NVMe interface method and may also support a Single-Root Input/Output (IO) Virtualization (SR-IOV) function.

In various embodiments, the host 200 may include a host core 230, a hypervisor/virtualization intermediary 240, a PCIe root complex 250, a host memory 220, and a storage interface 260.

In various embodiments, the machines 231 of FIG. 3 may be included in the host core 230 of the host 200, and may include a physical machine 231P (“PM”) and multiple virtual machines 231V-1 and 231V-2 (“VM1” and “VM2”). The physical machine 231P may be a physical hardware core or processor. The virtual machines 231V-1 and 231V-2 may be virtual cores or virtual processors created by the virtualization operations of the Single-Root Input/Output (IO) Virtualization (SR-IOV) function, and may each run an operating system (OS) and an application independently. An OS running on a virtual machine may be referred to as a guest OS. In various embodiments, one storage device 300 may be connected to both the physical machine 231P and the virtual machines 231V-1 and 231V-2.

In various embodiments, the physical machine 231P and the virtual machines 231V-1 and 231V-2 may correspond to devices or units included in the vehicle 100 of FIG. 1, such as the ECUs 110, the detecting device 130, the driving unit 140, the input unit 150, and the connection control device 160. For example, at least one of the physical machine 231P and the virtual machines 231V-1 and 231V-2 may be a core or processor that processes data generated by the ECUs 110 of the vehicle 100. Alternatively, when the vehicle 100 includes sensors, at least one of the physical machine 231P or the virtual machines 231V-1 and 231V-2 may be a core or processor that processes data generated by the sensors. A physical function 321P (“PF”) allocated to a physical machine 231P of a host 200 that processes first data, a first virtual function 321V-1 (“VF1”) allocated to a first virtual machine 231V-1 of the host 200 that processes second data, and a second virtual function 321V-2 (“VF2”) allocated to a second virtual machine 231V-2 of the host 200 that processes third data.

In various embodiments, the hypervisor/virtualization intermediary 240 may be connected to and in communication with the host core 230 and the PCIe root complex 250. The hypervisor/virtualization intermediary 240, which may be a software layer for building a virtualization system, may provide logically separate hardware to each of the virtual machines 231V-1 and 231V-2. The hypervisor/virtualization intermediary 240 may also be referred to as a virtual machine monitor (VMM) and may encompass firmware or software for creating and running virtual machines.

In other words, an SR-IOV-capable device may be configured to include the hypervisor/virtualization intermediary 240 and may appear as multiple functions 321 with configuration spaces having base address registers (BARs) in PCI configuration space. The hypervisor/virtualization intermediary 240 may map the actual configuration spaces of virtual functions 321V-1 (“VF1”) and 321V-2 (“VF2”) to configuration spaces provided by the hypervisor/virtualization intermediary 240, as the virtual machines 231V-1 and 231V-2. Thereby, the hypervisor/virtualization intermediary 240 may assign the virtual functions 321V-1 and 321V-2 to the virtual machines 231V-1 and 231V-2, respectively.

In various embodiments, the host-storage system 1000 may support the virtualization function. For example, the storage device 300 may provide a physical function 321P (“PF”) for management and the virtual functions 321V-1 and 321V-2 to the host 200. The physical function 321P may be allocated to the physical machine 231P, while the virtual functions 321V-1 and 321V-2 may be allocated to the virtual machines 231V-1 and 231V-2.

In various embodiments, the physical function 321P may be a PCIe function of the storage device 300 supporting an SR-IOV interface, while the virtual functions 321V-1 and 321V-2 may be lightweight PCIe functions on the storage device 300 that also support the SR-IOV interface.

In various embodiments, the physical function 321P may include the extended capabilities of SR-IOV in the PCIe configuration space of the storage device 300. For example, the capabilities of the physical function 321P may be used to enable virtualization and configure and manage the SR-IOV functionality of the storage device 300, including exposing the virtual functions 321V-1 and 321V-2. The virtual functions 321V-1 and 321V-2 are associated with the physical function 321P of the storage device 300, and may represent virtualized instances of the storage device 300. The virtual functions 321V-1 and 321V-2 may have their own unique PCIe configuration spaces and share physical resources of the physical function 321P.

In a SR-IOV-capable storage device 300, the physical function 321P is discovered first, and reading the PCIe configuration space of the storage device 300, the virtual functions 321V-1 and 321V-2, which are supported on an SR-IOV-capable host, may be scanned and enumerated. Then, the virtual functions 321V-1 and 321V-2 may be allocated to the virtual machines 231V-1 and 231V-2.

In various embodiments, the PCIe root complex 250 represents the root of a hierarchy and may be connected to the hypervisor/virtualization intermediary 240, the host memory 220, and the storage interface 260. The PCIe root complex 250 may connect the host core 230 to the host memory 220 or connect the host core 230 and the host memory 220 to the storage interface 260.

In various embodiments, the host memory 220 may be connected to the hypervisor/virtualization intermediary 240, the host core 230, and the storage interface 260 through the PCIe root complex 250. The host memory 220 may be used as a working memory for, for example, the physical machine 231P of the host core 230 or the virtual machines 231V-1 and 231V-2. In this case, applications, file systems, and device drivers may be loaded into the host memory 220.

In various embodiments, the storage interface 260 may be connected to and in communication with the PCIe root complex 250 and may provide communication between the host 200 and the storage device 300. For example, the storage interface 260 may provide queue-based commands and data to the storage device 300, according to the NVMe protocol, or may receive information and data regarding processed commands from the storage device 300.

In various embodiments, the storage controller 310 may communicate with the host 200 through a queue-based interface method. The storage controller 310 may control the storage device 300 for storing data in at least one of a plurality of nonvolatile memories 331-1 through 331-n in response to commands received from the host 200. The storage controller 310 may control the storage device 300 for transmitting data stored in the nonvolatile memories 331-1 through 331-n to the host 200.

In various embodiments, the nonvolatile memories 331-1 through 331-n may be electrically connected to and in communication with the storage controller 310 through channels CHI through CHn, respectively. The nonvolatile memories 331-1 through 331-n are capable of performing operations, such as storing data or reading stored data under the control of the storage controller 310.

In various embodiments, the volatile memory 332 may function as a buffer memory, storing data temporarily when the data is written to or read from the nonvolatile memories 331-1 through 331-n under the control of the storage controller 310, but the present disclosure is not limited thereto.

In various embodiments, the host memory 220 may provide storage areas for storing queue commands to support both the queue-based interface method and the virtualization function. In other words, the host memory 220 may provide separate storage areas for storing queue commands to support the queue-based command interface method along with the virtualization function.

In various embodiments, to support SR-IOV of an NVMe protocol interface method, the host memory 220 may provide a physical function management queue storage area 221-1 (“PF Admin_Q Area”) for storing a management queue for the physical function 321P, a physical function I/O queue storage area 221-2 (“PF UO_Q Area”) for storing an I/O queue for the physical function 321P, and multiple virtual function I/O queue storage areas 222-2 and 223-2 (“VF1 I/O_Q Area” and “VF2 I/O_Q Area”) for storing I/O queues for the virtual functions 321V-1 and 321V-2. Queue commands may be stored in these storage areas using a circular queue format for the NVMe protocol.

In various embodiments, separate independent management queues may be assigned to the virtual functions 321V-1 and 321V-2, respectively. For example, virtual function management queue “VF1 Administrator Queue” may be assigned to the virtual function 321V-1, and virtual function management queue “VF2 Administrator Queue” which can be independent of the virtual function management queue “VF1 Administrator Queue” may be assigned to the virtual function 321V-2. Therefore, the virtual functions 321V-1 and 321V-2 can perform queue management and command/data transaction operations independently using their respective virtual function management queues.

In various embodiments, the virtual function management queue “VF1 Administrator Queue” may be assigned to the guest OS of the virtual machine 231V-1, and the virtual function 321V-1 may independently perform queue management operations and command/data exchange operations using a virtual function management queue stored in a virtual function management queue area 222-1 of the host memory 220 and multiple virtual function I/O queues stored in a virtual function I/O queue area 222-2 of the host memory 220.

In various embodiments, the virtual function management queue “VF2 Administrator Queue” may be assigned to the guest OS of the virtual machine 231V-2, and the virtual function 321V-2 may independently perform queue management operations and command/data exchange operations using a virtual function management queue stored in a virtual function management queue area 223-1 of the host memory 220 and multiple virtual function I/O queues stored in a virtual function I/O queue area 223-2 of the host memory 220.

In various embodiments, the hypervisor/virtualization intermediary 240 may not need to intervene in an overall virtualization operation, and may be involved in SR-IOV capability initialization through, for example, the physical function 321P.

To store the virtual function management queues corresponding to the virtual functions 321V-1 and 321V-2, the host memory 220 may provide storage areas for storing pairs of management queues and I/O queues. The host memory 220 may additionally provide multiple virtual function management queue storage areas 222-1 (“VF1 Admin_Q Area”) and 222-2 (“VF2 Admin_Q Area”). In various embodiments, each virtual function management queue and each virtual function I/O queue may be stored in the host memory 220 in the circular queue format.

In various embodiments, the host-storage system 1000 may be implemented as a full isolation storage system, where the physical function 321P and the virtual functions 321V-1 and 321V-2 can be assigned with independent management queues and I/O queues. The total power budget of the storage device 300 can be independently allocated to the physical function 321P and the virtual functions 321V-1 and 321V-2, and the power supplied to memory regions corresponding to the physical function 321P and the virtual functions 321V-1 and 321V-2 among a plurality of memory regions in the memory device 330, can be adjusted independently. The memory regions corresponding to the physical function 321P and the virtual functions 321V-1 and 321V-2 respectively will be described later with reference to FIG. 5.

FIG. 4 illustrates that the host core 230 includes one physical machine 231P and two virtual machines 231V-1 and 231V-2, but the present disclosure is not limited thereto. The number of physical machines and virtual machines included in the host core 230 may vary. Similarly, the number of physical functions and virtual functions included in the storage controller 310 may also vary.

Furthermore, FIG. 4 illustrates that one physical function 321P is allocated to one physical machine 231P and one virtual function 321V-1 or 321V-2 is allocated to one virtual machine 231V-1 or 231V-2, but the present disclosure is not limited thereto. Multiple physical functions may be allocated to one physical machine 231P, and multiple virtual functions may also be allocated to each of the virtual machines 231V-1 and 231V-2.

In various embodiments, the host-storage system 1000 may include one physical machine 231P and two virtual machines 231V-1 and 231V-2, and that the physical machine 231P and the two virtual machines 231V-1 and 231V-2 are assigned one physical function 321P and two virtual functions 321V-1 and 321V-2, respectively.

FIG. 5 is a detailed block diagram of the host-storage system of FIG. 3.

Referring to FIG. 5, a nonvolatile memory (NVM) 331 may include multiple memory pages, where the memory pages may be subdivided into memory regions MR1, MR2, and MR3. Each of the memory pages may include multiple memory cells connected to wordlines, and a number of memory pages may form a memory block. Consequently, the nonvolatile memory 331 may include multiple memory blocks.

In various embodiments, memory regions MR1, MR2, and MR3 of the memory device 330 may include memory pages MP1, memory pages MP2, and memory pages MP3, respectively. The nonvolatile memory 331 may further include memory pages other than the memory pages MP1, MP2, and MP3.

In various embodiments, the volatile memory 332 may include regions R1, R2, and R3. The regions R1, R2, and R3 may correspond to DRAM or SRAM chips, but the present disclosure is not limited thereto.

In various embodiments, the memory device 330 may include the memory regions MR1, MR2, and MR3. The memory region MR1 may include the memory pages MP1 of the nonvolatile memory 331 and the region R1 of the volatile memory 332. The memory region MR2 may include the memory pages MP2 of the nonvolatile memory 331 and the region R2 of the volatile memory 332. The memory region MR3 may include the memory pages MP3 of the nonvolatile memory 331 and the region R3 of the volatile memory 332.

In various embodiments, each of the memory regions MR1, MR2, and MR3 of the memory device 330 may be composed of the combination of a non-volatile memory and a volatile memory, but the present disclosure is not limited thereto. Alternatively, each of the memory regions MR1, MR2, and MR3 may consist solely of non-volatile memories or solely of volatile memories.

In various embodiments, the memory region MR1 may be associated with the physical function 321P, the memory region MR2 may be associated with the virtual function 321V-1, and the memory region MR3 may be associated with the virtual function 321V-2. The physical machine 231P may communicate with and use the memory region MR1, the virtual machine 231V-1 may communicate with and use the memory region MR2, and the virtual machine 231V-2 may communicate with and use the memory region MR3 for data storage. For example, data processed by the physical machine 231P may be stored in the memory region MR1, and the physical machine 231P may read data stored in the memory region MR1. Similarly, data processed by the virtual machine 231V-1 may be stored in the memory region MR2, and the virtual machine 231V-1 may read data stored in the memory region MR2. Similarly, data processed by the virtual machine 231V-2 may be stored in the memory region MR3, and the virtual machine 231V-2 may read data stored in the memory region MR3.

In various embodiments, data generated or processed by the device or unit of the vehicle 100 that corresponds to the physical machine 231P may be stored in the memory region MR1 or may be read from the memory region MR1 via the physical function 321P. Additionally, data generated or processed by the device or unit of the vehicle 100 that corresponds to the virtual machine 231V-1 may be stored in the memory region MR2 via the virtual function 321V-1 or may be read from the memory region MR2 via the virtual function 321V-1. Similarly, data processed by the device or unit of the vehicle 100 that corresponds to the virtual machine 231V-2 may be stored in the memory region MR3 via the virtual function 321V-2 or may be read from the memory region MR3 via the virtual function 321V-2.

In various embodiments, the amount of data generated or processed by the devices or units of the vehicle 100 may vary depending on the operating mode of the vehicle 100. Accordingly, the amounts of a power budget that should be allocated to the physical functions 321P and virtual functions 321V-1 and 321V-2, which correspond to the respective devices or units of the vehicle 100, may differ. In the host-storage system 1000 of FIG. 5, independent management queues and I/O queues are assigned to the physical function 321P and the virtual functions 321V-1 and 321V-2, as illustrated in FIG. 4. Consequently, the amounts of a power budget allocated to the physical function 321P and the virtual functions 321V-1 and 321V-2 can be managed independently based on the operating mode of the vehicle 100.

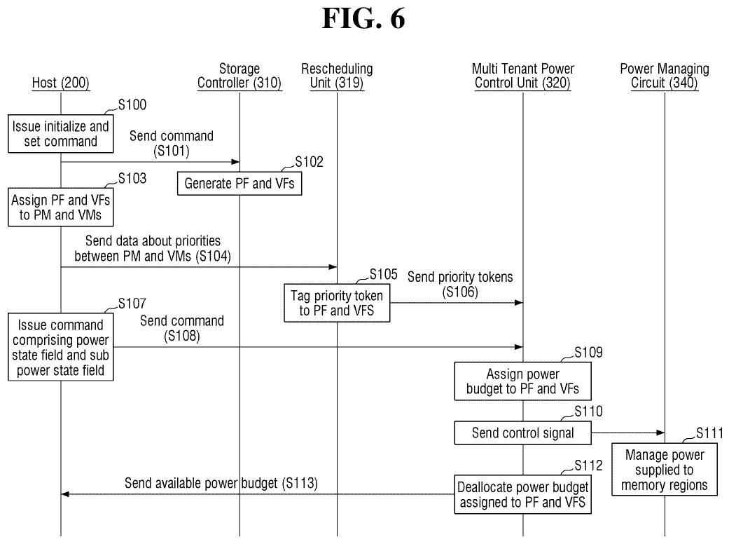

FIG. 6 is a flowchart illustrating the operation of the host-storage system of FIG. 3. The same reference numerals used in the previous embodiments will hereinafter be used throughout the rest of the present disclosure.

Referring to FIG. 6, initially, the host 200 may issue initialize and set commands (S100) and send the initialization and set commands to the storage controller 310 (S101). The storage controller 310 may receive the initialize and set commands and may create the physical function (PF) 321P and the virtual functions (VFs) 321V-1 and 321V-2 (S102). Thereafter, the host 200 may allocate the physical function 321P and the virtual functions 321V-1 and 321V-2 to the physical machine 231P and the virtual machines 231V-1 and 231V-2, respectively (S103).

Thereafter, the host 200 may transmit data regarding priorities among the physical machine 231P and the virtual machines 231V-1 and 231V-2 to the rescheduling unit 319 (S104). For example, the host 200 may transmit information to the storage controller 310 regarding which of the physical machine 231P and the virtual machines 231V-1 and 231V-2 is expected to have high power consumption due to factors such as, for example, generating a considerable amount of data or processing data rapidly, or is expected to have relatively low power consumption, depending on the operating mode (or driver mode) of the vehicle 100.

Thereafter, the rescheduling unit 319 may allocate priority tokens to each of the physical function 321P and the virtual functions 321V-1 and 321V-2 based on the data received from the host 200 (S105). Thereafter, the rescheduling unit 319 may transmit data regarding the allocated priority tokens for each of the physical function 321P and the virtual functions 321V-1 and 321V-2 to the multi-tenant power control unit 320 (S106). In response to an amount of data processed, the rescheduling unit 319 may be configured to allocate more priority tokens to the first virtual function 321V-1 than to the second virtual function 321V-2.

Thereafter, the host 200 may issue a command that includes a power state field for the storage device 300 and sub-power state fields for the physical function 321P and the virtual functions 321V-1 and 321V-2 (S107) and may send the command to the multi-tenant power control unit 320 (S108).

Thereafter, the multi-tenant power control unit 320 may allocate a power budget to the physical function 321P and the virtual functions 321V-1 and 321V-2 based on the power state of the storage device 300 and the assigned priority token quantities and the sub-power states of the physical function 321P and the virtual functions 321V-1 and 321V-2 (S109). In response to an amount of data processed, the multi-tenant power control unit 320 may be configured to allocate more of the power budget to the physical function 321P than to the first virtual function 321V-1.

Thereafter, the multi-tenant power control unit 320 may send control signals to the power management circuit 340 (S110). The power management circuit 340 may independently manage the power supplied to the memory regions MR1, MR2, and MR3 based on the control signals. The control signals may contain information regarding the power budget allocated by the multi-tenant power control unit 320 to the physical function 321P and the virtual functions 321V-1 and 321V-2. The power management circuit 340 may manage the power supplied to the memory regions MR1, MR2, and MR3, which correspond to the physical function 321P and the virtual functions 321V-1 and 321V-2, respectively, based on the power budget allocated to each of the physical function 321P and the virtual functions 321V-1 and 321V-2.

In various embodiments, if the power budget allocated by the multi-tenant power control unit 320 to the virtual function 321V-1 decreases, the power management circuit 340 may reduce the amount of power supplied to the memory region MR2 corresponding to the virtual function 321V-1. Conversely, if the power budget allocated by the multi-tenant power control unit 320 to the virtual function 321V-2 increases, the power management circuit 340 may increase the amount of power supplied to the memory region MR3 corresponding to the virtual function 321V-2. Therefore, as mentioned earlier with reference to FIG. 4, when the host-storage system 1000 is implemented as a full isolation storage system, the power management circuit 340 can independently manage the power supplied to each of the memory regions MR1, MR2, and MR3 corresponding to the physical function 321P and the virtual functions 321V-1 and 321V-2, respectively.

Thereafter, the multi-tenant power control unit 320 may select one of the physical function 321P and the virtual functions 321V-1 and 321V-2 and may release the power budget allocated to the selected function (S112). Moreover, the multi-tenant power control unit 320 may report and transmit information regarding any additional available power budget to the host 200 (S113).

In various embodiments, the host 200 may send data regarding the priorities among the physical machine 231P and the virtual machines 231V-1 and 231V-2 to the rescheduling unit 319 first and then send a command containing the power state field for the storage device 300 and the sub-power state fields for the physical function 321P and the virtual functions 321V-1 and 321V-2 to the multi-tenant power control unit 320, but the present disclosure is not limited thereto. Alternatively, in some embodiments, the host 200 may send the command containing the power state field for the storage device 300 and the sub-power state fields for the physical function 321P and virtual functions 321V-1 and 321V-2 to the multi-tenant power control unit 320 first and then send the data regarding the priorities among the physical machine 231P and the virtual machines 231V-1 and 231V-2 to the rescheduling unit 319.

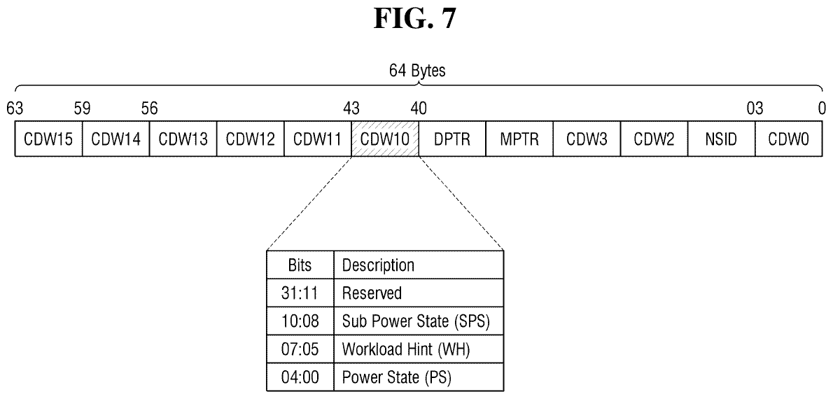

FIG. 7 is a schematic view illustrating an exemplary command issued by the host of FIG. 6.

Referring back to FIG. 4, the host 200 may send a command instructing a specific action to be executed to the storage device 300 and may receive a response signal for the sent command from the storage device 300. For this purpose, the host 200 may include a submission queue for temporarily storing commands to be sent to the storage device 300 and a completion queue for temporarily storing response signals received from the storage device 300.

FIG. 7 illustrates a submission queue entry for a command issued by the host of FIG. 6. Referring to FIG. 7, the NVMe standard defines the submission queue entry. The submission queue entry may be composed of, for example, 16 command double words, and may have a size of 64 bytes. Each command double word may be 4 bytes in size.

In various embodiments, the submission queue entry may include command double word 0 (“CDW 0”), a namespace identifier (“NSID”), command double word 2 (“CDW 2”), command double word 3 (“CDW 3”), a metadata pointer (“MPTR”), a data pointer (“DPTR”), command double word 10 (“CDW 10”), command double word 11 (“CDW 11”), command double word 12 (“CDW 12”), command double word 13 (“CDW 13”), command double word 14 (“CDW 14”), and command double word 15 (“CDW 15”). However, the configuration of the submission queue entry is not limited to that illustrated in FIG. 7.

In S107 of FIG. 6, one of command double words 0, 2, 3, 10, 11, 12, 13, 14, and 15 of the submission queue entry may be used for a command issued by the host 200, including a power state field and sub-power state fields. FIG. 7 illustrates that the command issued by the host 200 uses command double word 10 of the submission queue entry, but the present disclosure is not limited thereto. In the following description, it is assumed that a command issued by the host 200 uses an arbitrary command double word, i.e., command double word N (“CDW N”) within the submission queue entry.

In various embodiments, the command double word N may include a power state field PS, a workload hint field WH, and a sub-power state field SPS. Referring to FIG. 7, the sub-power state field SPS may be positioned after the power state field PS. The sub-power state field SPS may consist of multiple bits, for example, three bits, but the present disclosure is not limited thereto.

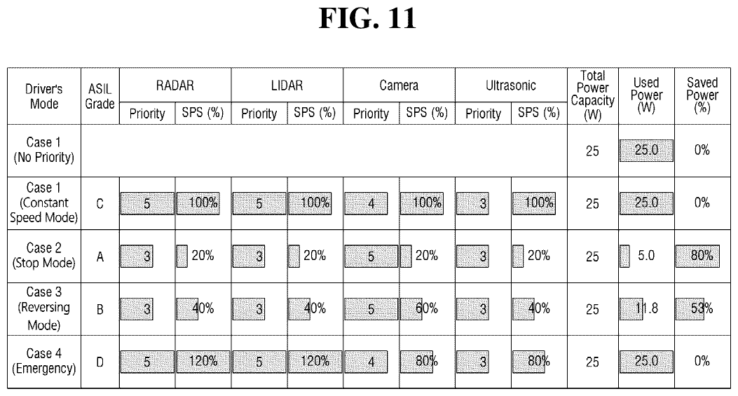

In various embodiments, the power state field PS may include information regarding a power state transmitted by the storage controller 310. The power state may represent (or indicate) the total power budget of the storage device 300. The total power budget of the storage device 300 may be determined within the total power capacity of the storage device 300. The total power budget of the storage device 300 will be described later with reference to FIG. 11.

In various embodiments, the workload hint field WH may be positioned between the power state field and the sub-power state field. The workload hint field WH may indicate the type of workload.

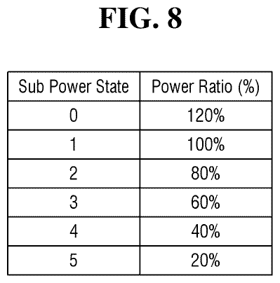

In various embodiments, the sub-power state field SPS may include information regarding the sub-power state of at least one of the physical function 321P and the virtual functions 321V-1 and 321V-2 of the storage controller 310. The sub-power states of the physical function 321P and the virtual functions 321V-1 and 321V-2 will hereinafter be described with reference to FIG. 8.

FIG. 8 presents a table for explaining different sub-power states that can be included in the command of FIG. 7.

Referring to FIG. 8, the sub-power state field SPS included in the command of FIG. 7 may contain information regarding the power allocation ratio for at least one of the physical function 321P or the virtual functions 321V-1 or 321V-2 of the storage controller 310. For example, when the sub-power state SPS is set to values of 0, 1, 2, 3, 4, and 5, the power allocation ratio may be set to 120%, 100%, 80%, 60%, 40%, and 20%, respectively, but the present disclosure is not limited thereto.

As the amount of data processed by each of the physical machine 231P and the virtual machines 231V-1 and/or 231V-2 increases, the power allocation ratio for each of the physical function 321P and the virtual functions 321V-1 and/or 321V-2 may also increase. When a larger amount of the power budget is allocated to each of the physical machine 231P and the virtual machines 231V-1 and 231V-2, the nonvolatile memory 331 and the volatile memory 332 of the memory device 330 may be additionally used.

For example, in response to an increase in the amount of data processed by the physical machine 231P, among other devices or units of the vehicle 100, in accordance with a change in the operating mode of the vehicle 100, the host 200 may insert a sub-power state field SPS with a higher power allocation ratio for the physical function 321P into a command and may send the command to the storage controller 310. Conversely, in response to a decrease in the amount of data processed by the virtual machine 231V-1, among other devices or units of the vehicle 100, in accordance with a change in the operating mode of the vehicle 100, the host 200 may insert a sub-power state field SPS with a lower power allocation ratio for the virtual function 321V-1 into a command and may send the command to the storage controller 310.

In various embodiments, as the power allocation ratios for the physical function 321P and the virtual functions 321V-1 and 321V-2 increase, the physical machine 231P and the virtual machines 231V-1 and 231V-2 may be able to process data faster.

In this manner, the multi-tenant power control unit 320 of the storage controller 310 may obtain information regarding the sub-power states and power allocation ratios for the physical function 321P and the virtual functions 321V-1 and 321V-2 through commands received from the host 200, such as NVMe commands.

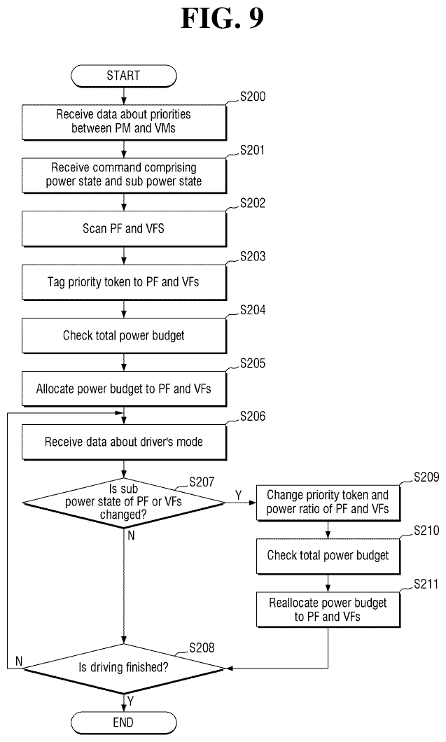

FIG. 9 is a flowchart illustrating the operation of a storage controller according to some embodiments of the present disclosure.

Referring to FIG. 9, the storage controller 310 may receive data regarding the priorities among the physical machine 231P and the virtual machines 231V-1 and 231V-2 from the host 200 (S200). The storage controller 310 may receive a command containing information regarding a power state and sub-power states from the host 200 (S201). Through the received command, the storage controller 310 may obtain information regarding the total power budget of the storage device 300 and the sub-power states and power allocation ratios for each of the physical function 321P and the virtual functions 321V-1 and 321V-2.

In various embodiments, the storage controller 310 may scan the physical function 321P and the virtual functions 321V-1 and 321V-2 (S202). Through this scanning operation, the storage controller 310 may collect information regarding the number of physical functions and virtual functions to which the power budget is to be allocated, and the sub-power states and power allocation ratios for the physical functions and virtual functions. For example, the collected information may include the sub-power states and power allocation ratios for the physical function 321P and the virtual functions 321V-1 and 321V-2.

In various embodiments, the rescheduling unit 319 of the storage controller 310 may allocate priority tokens to each of the physical function 321P and the virtual functions 321V-1 and 321V-2 based on the information obtained in S200 and S201 (S203). In S203, a larger amount of the power budget may be allocated to a physical or virtual function with a relatively larger number of priority tokens. Accordingly, a physical or virtual machine corresponding to a physical or virtual function with a lower amount of power budget allocated thereto can process data faster than other physical or virtual machines.

In various embodiments, the multi-tenant power control unit 320 may identify the total power budget of the storage device 300 (S204). For example, the multi-tenant power control unit 320 may identify the total power budget of the storage device 300 through a power state field PS included in the command received from the host 200 in S201.

In various embodiments, the multi-tenant power control unit 320 may allocate power budget to each of the physical function 321P and the virtual functions 321V-1 and 321V-2 (S205). The multi-tenant power control unit 320 may allocate the power budget using Equation

$$Power Budget Allocated to PF or VFs = \frac{\begin{matrix}Assigned Priority Tokens * Power Allocation Ratio \\ for Sub Power State ( \% ) ⋆ Tower Power Budget ( W )\end{matrix}}{Total Number of Priority Tokens} \qquad ( 1 )$$

Referring to Equation (1) above, the power budget may be allocated to each of the physical function 321P and the virtual functions 321V-1 and 321V-2 based on the product of the number of assigned priority tokens and the power allocation ratio for the sub-power state of the corresponding function. The greater the number of priority tokens assigned by the rescheduling unit 319 and the greater the power allocation ratio for the sub-power state, the larger the amount of the power budget allocated to each of the physical function 321P and the virtual functions 321V-1 and 321V-2.

In various embodiments, the storage controller 310 may receive data regarding the operating mode of the vehicle 100 (S206). For example, if the operating mode of the vehicle 100 has changed between S201 and S206, the storage controller 310 may receive data regarding updated priorities among the physical machine 231P and the virtual machines 231V-1 and 231V-2. The storage controller 310 may obtain the data regarding the updated priorities among the physical machine 231P and the virtual machines 231V-1 and 231V-2.

In various embodiments, the storage controller 310 may issue a command containing information regarding an updated power state and sub-power states. The storage controller 310 may obtain information regarding an updated total power budget of the storage device 300 and updated sub-power states and power allocation ratios for the physical function 321P or virtual functions 321V-1 and 321V-2.

In various embodiments, the storage controller 310 may determine whether there has been a change in the sub-power state of the physical function 321P or the virtual functions 321V-1 and 321V-2 (S207). The storage controller 310 may determine whether the sub-power state of the physical function 321P or the virtual functions 321V-1 and 321V-2, included in the command received from the host 200 in step S206, has changed from that included in the command received from the host 200 in S201. In response, if neither the sub-power state of the physical function 321P nor the sub-power state of the virtual functions 321V-1 and 321V-2 has changed (S207-N), the storage controller 310 may determine whether the driving mode of the vehicle 100 has been completed (S208). Then, if it is determined in S208 that the driving mode of the vehicle 100 has been completed (S208-Y), the storage controller 310 may terminate its operation. Alternatively, if it is determined in S208 that the driving mode of the vehicle 100 has not ended (S208-N), the storage controller 310 can receive data regarding the operating mode of the vehicle 100 again (S206).

In various embodiments, if it is determined in S207 that the sub-power state of the physical function 321P or the sub-power state of the virtual functions 321V-1 and 321V-2 has changed (S207-Y), the rescheduling unit 319 may reassign priority tokens to each of the physical function 321P and the virtual functions 321V-1 and 321V-2 (S209) based on the data regarding the updated priorities among the physical machine 231P and the virtual machines 231V-1 and 231V-2, received from the host 200 in S206. For example, if the changed operating mode of the vehicle 100 leads to an increase in the amount of data generated or processed by a device or unit of the vehicle 100 with fewer assigned priority tokens, more priority tokens may be allocated to the corresponding function.

In various embodiments, the multi-tenant power control unit 320 may adjust the power allocation ratio for each of the physical function 321P and the virtual functions 321V-1 and 321V-2 (S209) based on the updated or changed sub-power states received in S206. For example, referring to FIG. 8, if the sub-power state of the physical function 321P is originally 0, resulting in a power allocation ratio of 120% for the physical function 321P, but changes to 3, the multi-tenant power control unit 320 can adjust the power allocation ratio for the physical function 321P from 120% to 60%.

In various embodiments, if the operating mode of the vehicle 100 changes and the amount of data processed by the physical machine 231P to which the physical function 321P is assigned decreases, or if there is a reduced need for rapid data processing by the physical machine 231P, the power allocation ratio for the physical function 321P may be reduced.

In various embodiments, the multi-tenant power control unit 320 may identify the total power budget of the storage device 300 (S210). For example, the multi-tenant power control unit 320 may identify the total power budget of the storage device 300 through a power state field PS included in the command received from the host 200 in S206.

In various embodiments, the total power budget of the storage device 300 may be adjusted depending on the change in the operating mode of the vehicle 100. For example, if the devices or units of the vehicle 100 generate or process a significant amount of data, as in a constant speed mode, the host 200 may set the total power budget of the storage device 300 higher. Conversely, if the devices or units of the vehicle 100 generate or process a small amount of data, as in a stop mode, the host 200 may set the total power budget for the storage device 300 lower.

In various embodiments, the multi-tenant power control unit 320 may allocate the power budget to each of the physical function 321P and the virtual functions 321V-1 and 321V-2 based on Equation (1) (S211). Consequently, the power budget can be redistributed among the devices or units of the vehicle 100 that share the storage device 300 depending on the operating mode of the vehicle 100.

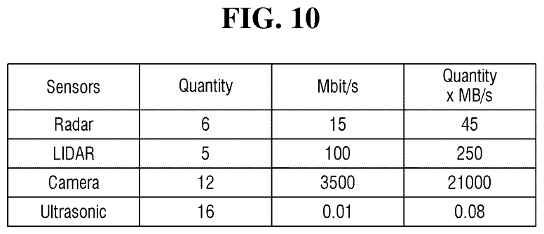

FIG. 10 presents a table for explaining data generated by sensors included in the vehicle of FIG. 1.

Referring to FIG. 10, the vehicle 100 may include various sensors for sensing the surroundings of the vehicle 100, i.e., a radar sensor, a Light Detection and Ranging (LIDAR) sensor, a camera sensor, and an ultrasonic sensor. Each of a first, second, and third module may include at least one of a radar sensor, a Light Detection and Ranging (LIDAR) sensor, a camera sensor, or an ultrasonic sensor.

FIG. 10 shows an example of the amount of data generated per second (e.g., megabits per second (MB/s)) by each of the sensors of the vehicle 100. As shown in FIG. 10, the sensors of the vehicle 100 may generate or process different amounts of data. Additionally, when the operating mode of the vehicle 100 changes, the amount of data generated by each of the sensors of the vehicle 100 may differ from what is shown in FIG. 10.

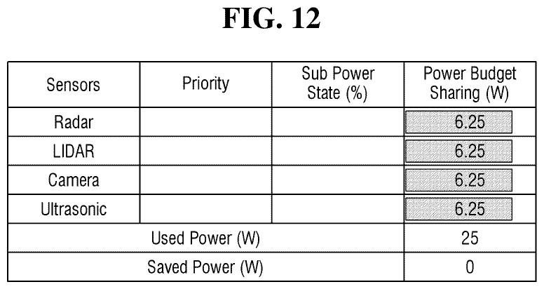

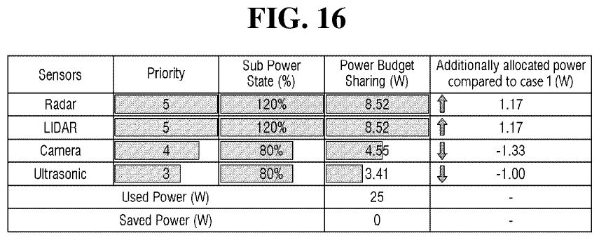

FIG. 11 presents a table showing priority tokens and sub-power states assigned to the sensors of FIG. 10 for different vehicle operating modes based on Automotive Safety Integrity Level (ASIL) ratings. FIGS. 12 through 16 present tables for explaining various cases, where the sensors of FIG. 10 share a power budget for different vehicle operating modes of the vehicle, and the operation of sharing and reallocating power budget among the sensors of the vehicle 100 for ASIL rating-based vehicle operating modes.

Referring to FIG. 11, the vehicle 100 may be classified into five operating modes (or driver modes). There may be a case (“Case 1”) where no priority is set among the sensors. Additionally, there may exist different modes depending on the ASIL grade of the advanced driver assistance system (ADAS) of the vehicle 100, i.e., constant speed mode (“Case 2”) corresponding to ASIL grade C, stop mode (“Case 3”) corresponding to ASIL grade A, reversing mode (“Case 4”) corresponding to ASIL grade B, and emergency mode (“Case 5”) corresponding to ASIL grade D.

As shown in FIG. 11, the total power capacity of the storage device 300 may be, for example, 25 W. The total power capacity of the storage device 300, such as an SSD, may be fixed to a predetermined value. Furthermore, the total power budget for the storage device 300 may be set within the total power capacity of the storage device 300, depending on the operating mode of the vehicle 100.

For example, if the sensors of the vehicle 100 generate or process a significant amount of data in general, the total power budget of the storage device 300 may be increased within the total power capacity of the storage device 300. Conversely, if the sensors of the vehicle 100 generate or process a small amount of data in general, the total power budget of the storage device 300 may be reduced within the total power capacity of the storage device 300. Information regarding the total power budget of the storage device 300 may be included in the power state field PS of the command of FIG. 7.

Referring to FIGS. 11 and 12, in Case 1 where priorities or sub-power states are set for none of the sensors of FIG. 10, the total power budget of the storage device 300 may be evenly distributed among the sensors of FIG. 10, with each sensor receiving an allocation of 6.25 W.

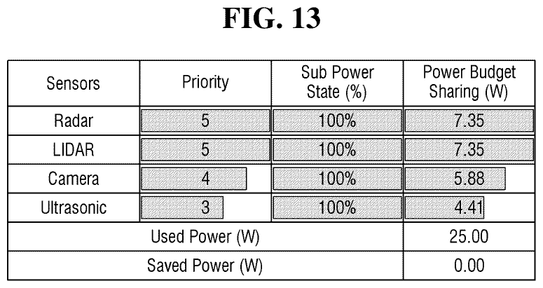

Referring to FIGS. 11 and 13, in Case 2, where the vehicle 100 is in constant-speed mode corresponding to ASIL grade C, there may be the need to allocate more power budget to the radar sensor and the LIDAR sensor compared to the camera sensor and the ultrasonic sensor. For example, during constant-speed driving, the camera sensor identifies objects and recognizes the colors, but cannot accurately measure the distances to the objects, and thus, there may be a reduced need for rapid data processing by the camera sensor. In contrast, there may be an increased need for rapid data processing by the radar sensor and the LIDAR sensor, which measure and detect the distances to the objects.

In various embodiments, the rescheduling unit 319 may assign five priority tokens to each to the radar sensor and the LIDAR sensor, four tokens to the camera sensor, and 3 tokens to the ultrasonic sensor, out of a total of 17 priority tokens.

Furthermore, when the vehicle 100 is in constant-speed driving, the sensors generate a relatively large amount of data. Thus, the host 200 may set the power allocation ratios for the functions corresponding to the respective sensors to 100% through the sub-power fields SPS of a command sent to the storage controller 310.

In various embodiments, the amount of the power budget allocated to each of the sensors may be calculated based on the assigned priority token quantities of the sensors and the power allocation ratios for the sub-power states of the sensors, using Equation (1).

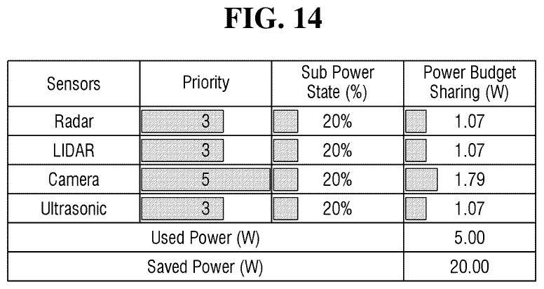

Referring to FIGS. 11 and 14, in Case 3, where the vehicle 100 is in stop mode corresponding to ASIL grade A, the importance of object identification around the vehicle 100 may decrease compared to constant speed mode (i.e., Case 2). Accordingly, the rescheduling unit 319 may reduce the number of priority tokens assigned to each of the radar sensor and LIDAR sensor while increasing the number of priority tokens assigned to the camera sensor.

When the vehicle 100 is at a complete stop, the sensors generate a relatively small amount of data. In various embodiments, the host 200 may set the power allocation ratios for the functions corresponding to the respective sensors at as low as 20% through the sub-power state fields SPS of a command sent to the storage controller 310.

In various embodiments, the amount of the power budget allocated to each of the sensors may be calculated based on the assigned priority token quantities and the sub-power states of the sensors, using Equation (1). Consequently, when the vehicle 100 is stationary, the total power used by the storage device 300 may be as low as 5 W, saving approximately 80% of power.

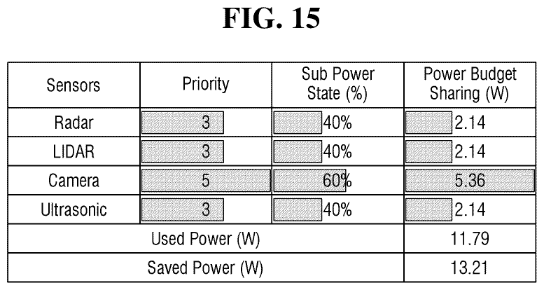

Referring to FIGS. 11 and 15, in Case 4 where the vehicle 100 is in reversing mode corresponding to ASIL grade B, there may be an additional need for power consumption for the rear camera of the vehicle 100. Accordingly, to allocate more power budget to the camera sensor, the rescheduling unit 319 may increase the number of priority tokens assigned to the camera sensor.

Furthermore, when the vehicle 100 is reversing, the sensors may consume relatively more power, and thus, the power allocation ratios for the sub-power states of the sensors may be set relatively higher than in Case 3 of FIG. 14. In various embodiments, the power allocation ratio for the camera sensor may be set higher compared to other sensors, such as the radar sensor.

In various embodiments, the amount of power budget allocated to each of the sensors may be calculated based on the assigned priority token quantities of the sensors and the power allocation ratios for the sub-power states of the sensors, using Equation (1). Consequently, when the vehicle 100 is reversing, the total power used by the storage device 300 may be approximately 11.79 W, saving about 53% of power.

Referring to FIGS. 11, 13, and 16, in Case 5 where the vehicle 100 is in emergency mode corresponding to ASIL grade D, the number of priority tokens assigned to each of the radar sensor, the LIDAR sensor, the camera sensor, and the ultrasonic sensor is the same as in constant speed mode (i.e., “Case 2” of FIG. 13). However, some (i.e., 20%) of the power allocation ratios for the camera sensor and ultrasonic sensor, which have fewer assigned priority tokens, may be reallocated to the radar sensor and the LIDAR sensor, which have more assigned priority tokens. Consequently, compared to constant speed mode in FIG. 13, about 1.33 W and 1.00 W of power may be deallocated from the camera sensor and ultrasonic sensor, respectively, and about 1.17 W of power may be additionally allocated to each of the radar sensor and the LIDAR sensor.

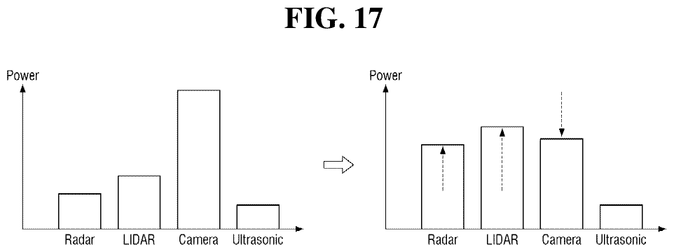

FIG. 17 presents graphs for explaining the reallocation of power budget among the sensors of FIG. 10.

Referring to FIG. 17, as mentioned earlier, the sensors of the vehicle 100, which share the storage device 300, may share the total power budget of the storage device 300. The total power budget of the storage device 300 may be allocated to each of the sensors of the vehicle 100 depending on the operating mode of the vehicle 100. As the host-storage system 1000, including the storage device 300, can be implemented as a full isolation storage system, allocated power for each of the sensors can be independently managed. For example, if the camera sensor is allocated an excessive power budget, the allocated power budget for the camera sensor may be deallocated to conserve power, and the deallocated power budget may be additionally allocated to the radar sensor and the LIDAR sensor, which require an additional power budget. The power budget allocated to the ultrasonic sensor may be maintained independently. As a result, the total power budget of the storage device 300 can be efficiently managed.

Embodiments of the present disclosure have been described above with reference to the accompanying drawings, but the present disclosure is not limited thereto and may be implemented in various different forms. It will be understood that the present disclosure can be implemented in other specific forms without changing the technical spirit or gist of the present disclosure. Therefore, it should be understood that the embodiments set forth herein are illustrative in all respects and not limiting.

What is claimed is:

1. A storage controller comprising:
a physical function allocated to a physical machine of a host that processes first data;
a first virtual function allocated to a first virtual machine of the host that processes second data;
a second virtual function allocated to a second virtual machine of the host that processes third data;
a rescheduling unit configured to assign priority tokens to each of the physical function, the first virtual function, and the second virtual function; and
a multi-tenant power control unit configured to receive sub-power states of the physical function, the first virtual function, and the second virtual function, and allocate a power budget to each of the physical function, the first virtual function, and the second virtual function based on the assigned priority tokens and the sub-power states.

2. The storage controller of claim 1, wherein in response to the number of priority tokens assigned to the physical function being greater than the number of priority tokens assigned to the first virtual function, the multi-tenant power control unit is configured to allocate more of the power budget to the physical function than to the first virtual function.

3. The storage controller of claim 1, wherein the multi-tenant power control unit is configured to allocate the power budget to the first virtual function based on the product of the number of priority tokens assigned to the first virtual function and a power allocation ratio for the sub-power state of the first virtual function.

4. The storage controller of claim 1, wherein the sub-power states of the physical function, the first virtual function, and the second virtual function are included in a Non-Volatile Memory Express (NVMe) command issued by the host.

5. The storage controller of claim 1, wherein each of the physical function, the first virtual function, and the second virtual function is configured to process data generated from any one of a radar sensor, a Light Detection and Ranging (LIDAR) sensor, a camera sensor, or an ultrasonic sensor.

6. The storage controller of claim 5, wherein
the physical function is configured to process data generated from the camera sensor,
the first virtual function is configured to process data generated from the ultrasonic sensor,
the second virtual function is configured to process data generated from at least one of the radar sensor, or the LIDAR sensor, and
when a vehicle is in emergency mode, the multi-tenant power control unit is configured to reallocate the power budget allocated to each of the physical function and the first virtual function to the second virtual function.

7. A storage device comprising:
a storage controller configured to generate a physical function, which is allocated to a physical machine of a host that processes first data, a first virtual function, which is allocated to a first virtual machine of the host that processes second data, and a second virtual function, which is allocated to a second virtual machine of the host that processes third data;
a memory device including a first memory region which corresponds to the physical function, a second memory region which corresponds to the first virtual function, and a third memory region which corresponds to the second virtual function; and
a power management circuit controlled by the storage controller to manage power supplied to each of the first, second, and third memory regions,
wherein
the storage controller includes a rescheduling unit, which is configured to assign priority tokens to each of the physical function, the first virtual function, and the second virtual function, and a multi-tenant power control unit, which is configured to receive sub-power states of the physical function, the first virtual function, and the second virtual function, and allocate a power budget to each of the physical function, the first virtual function, and the second virtual function based on the assigned priority tokens and the sub-power states of the physical function, the first virtual function, and the second virtual function, and
the power management circuit is controlled by the multi-tenant power control unit to independently manage power supplied to each of the first, second, and third memory regions based on the power budget allocated to each of the physical function, the first virtual function, and the second virtual function.

8. The storage device of claim 7, wherein in response to an amount of data processed by the physical machine being greater than an amount of data processed by the first virtual machine, the multi-tenant power control unit is configured to allocate more power budget to the physical function than to the first virtual function.

9. The storage device of claim 7, wherein in response to an amount of data processed by the first virtual machine being greater than an amount of data processed by the second virtual machine, the rescheduling unit is configured to allocate more priority tokens to the first virtual function than to the second virtual function.

10. The storage device of claim 7, wherein
the memory device includes a nonvolatile memory, which includes a plurality of memory pages,
the plurality of memory pages includes first memory pages, second memory pages, and third memory pages,
the first memory region includes first memory pages,
the second memory region includes second memory pages, and
the third memory regions include third memory pages.

11. The storage device of claim 10, wherein
the memory device further includes a volatile memory,
the volatile memory includes a first region, a second region, and a third region,
the first memory region further includes the first region of the volatile memory,
the second memory region further includes the second region of the volatile memory, and
the third memory region further includes the third region of the volatile memory.

12. A host-storage system comprising:
a host including a physical machine that processes first data, a first virtual machine that processes second data, and a second virtual machine that processes third data;
a storage controller configured to generate a physical function allocated to the physical machine, a first virtual function allocated to the first virtual machine, and a second virtual function allocated to the second virtual machine; and
a memory device including a first memory region which corresponds to the physical function, a second memory region which corresponds to the first virtual function, and a third memory region which corresponds to the second virtual function,
wherein
the host is configured to provide a command, which includes a power state field for a storage device including the storage controller and the memory device, and a sub-power state field for at least one of the physical function, the first virtual function, or the second virtual function, and
the storage controller is configured to receive the command and allocate a power budget to at least one of the physical function, the first virtual function, or the second virtual function based on the sub-power state field of the command.

13. The host-storage system of claim 12, wherein the sub-power state field is composed of multiple bits.

14. The host-storage system of claim 13, wherein the sub-power state field is composed of three bits.

15. The host-storage system of claim 12, wherein
the storage controller includes a multi-tenant power control unit, and
the multi-tenant power control unit is configured to identify total power budget of the memory device, and allocate the power budget to each of the physical function, the first virtual function, and the second virtual function based on sub-power states specified in sub-power state fields of the physical function, the first virtual function, and the second virtual function, included in the command.

16. The host-storage system of claim 15, wherein
the storage controller further includes a rescheduling unit, and
the rescheduling unit is configured to assign priority tokens to each of the physical function, the first virtual function, and the second virtual function.

17. The host-storage system of claim 16, wherein the multi-tenant power control unit is configured to allocate the power budget to the physical function based on the product of the number of priority tokens assigned to the physical function and a power allocation ratio for the sub-power state of the physical function.

18. The host-storage system of claim 16, wherein in response to the number of priority tokens assigned to the first virtual function being greater than the number of priority tokens assigned to the second virtual function, and a power allocation ratio for the sub-power state of the first virtual function being greater than or the same as a power allocation ratio for the sub-power state of the second virtual function, the multi-tenant power control unit is configured to allocate more of the power budget to the first virtual function than to the second virtual function.

19. The host-storage system of claim 15, further comprising:
a power management circuit controlled by the multi-tenant power control unit to independently manage power supplied to each of the first, second, and third memory regions based on the power budget allocated to each of the physical function, the first virtual function, and the second virtual function.

20. The host-storage system of claim 19, wherein in response to an amount of power budget allocated to the first virtual function being greater than an amount of power budget allocated to the second virtual function, the power management circuit is configured to reallocate some of the power supplied to the second memory region to the first memory region.
